(19) United States
(12) Patent Application Publication
(10) Pub. No.: US 2007/0284032 A1
(43) Pub. Date: Dec. 13, 2007

(54) Method for the production of a film

(76) Inventors: Detlef Stoppelmann, Steinfeld (DE); Marcus Kujat, Osnabruck (DE); Alfons Kruse, Dinklage (DE); Jochen Brauer, Lohne (DE)

Correspondence Address: WILLIAM COLLARD;COLLARD & ROE, P.C., 1077 NORTHERN BOULEVARD, ROSLYN, NY, 11576, US

(21) Appl. No.: 11/789,592

(22) Filed: Apr. 25, 2007

(30) Foreign Application Priority Data
Apr. 26, 2006 (EP) 06 008 602.2

(51) Int. Cl. B32B 38/04

(52) U.S. Cl. 156/272.8

(57) ABSTRACT

A method for the production of a film for tear-open packagings having a weakening line. A film web having at least one film layer of a thermoplastic plastic is passed to a hot-embossing device, in which the film web is provided with a line-shaped embossing. The film web is then passed to a laser beam device, in which the film web is provided with a line-shaped laser seam. The embossing and the laser seam cover each other and jointly form the weakening line.

### BACKGROUND OF THE INVENTION

1. Field of the Invention

The invention relates to a method for the production of a film for tear-open packagings having a weakening line. A tear-open packaging can be formed from a folded segment of the film, or from two sheets of film cut from the film, which packaging is closed by sealed or glued seams, for example. In this connection, the weakening line is typically disposed in such a manner that it runs essentially parallel to one of the sides of the tear-open packaging. The weakening line allows simple and controlled tearing open.

2. The Prior Art

A tear-open packaging formed from a film having a weakening line is known from German Patent No. DE 41 09 605 A1. The tube-shaped tear-open packaging is folded from a film sheet and closed by a sealing seam that runs in the longitudinal direction and two end-side sealing seams. The film is laminated in multiple layers, and the weakening line is produced before lamination, in one of the film layers, by cuts, thermal production of brittleness, or an embossing. Embossing before lamination is complicated and only allows easy tearing open of the tear-open packaging in the case of specific layer compositions.

International Application Publication No. WO 98/29312 describes a method for the production of a tear-open packaging having a weakening line that is produced exclusively by a laser beam. Before the packaging is produced from the film, the film material is removed up to a center layer of light metal, from the side of the multi-layer film that forms the inside of the packaging. In this connection, high laser output is required for material removal by the laser beam alone, and the laser output must be precisely adapted to the thickness and the composition of the at least one layer to be removed, in order to adhere to a pre-determined removal of material.

European Patent No. EP 0 875 369 B1 describes a method for the production of a packaging, where the packaging is first formed from two film sheets. Subsequently, tear cuts are produced at the surface of the bag that has already been formed, by a laser beam. Since the production of the weakening line is only provided after the bag has already been formed, the method presented is inflexible.

The possibility of laser processing of a single film layer is particularly dependent on the polymer composition. Since a weakening is generally supposed to be produced by a laser beam only in individual layers, the selection of suitable layer compositions of a multi-layer film is extremely limited.

### SUMMARY OF THE INVENTION

With this background, it is therefore an object of the invention to provide a method for the production of a film for tear-open packagings having a weakening line, which method allows simple production of the weakening line and can be flexibly adapted to films configured in different ways.

This object is accomplished according to the invention by a method for the production of a film for tear-open packagings having a weakening line, wherein a film web having at least one film layer of a thermoplastic plastic is passed to a hot-embossing device, in which the film web is provided with a line-shaped embossing. The film web is passed to a laser beam device, which provides the film web with a line-shaped laser seam. The embossing and the laser seam cover each other and jointly form the weakening line. Via the combination of a hot-embossing device and a laser beam device for producing a weakening line, flexible adaptation to the composition of the film and, in the case of a multi-layer film, also to the layer structure, is possible. In the hot-embossing device, the film is deformed under the effect of pressure and temperature. The extent to which an individual film layer deforms in the hot-embossing device depends essentially on the embossing temperature and the pressure exerted. These two parameters can be freely varied in accordance with the requirements. In the laser beam device, heating takes place as a function of the absorption capacity of the polymer being irradiated, and typically, material removal takes place by evaporation. The intensity of the laser beam decreases with an increasing penetration depth. The wavelength of the laser and the laser output can be selected in accordance with the requirements.

In a preferred embodiment of the method according to the invention, the film web is provided with a plurality of weakening lines spaced apart in the running direction of the film web. The weakening lines can run, without restriction, crosswise to the running direction of the film web, but also at a slant, arced, or at an angle. In order to produce the weakening lines that are spaced apart in the running direction of the film web, the advance of the film web does not take place continuously but rather in cycles, and the film web rests in the region of the hot-embossing device and the laser beam device, when the weakening lines are formed. Preferably, the line-shaped embossing is produced by an embossing beam. Subsequently, the film web is transported further to the laser beam device, in which—also with the film web at rest—the progression of the line-shaped embossing is followed up by a laser beam. If the line-shaped embossing runs crosswise to the running direction, its progression can be followed up by a simple linear movement of the laser beam in the crosswise direction. If the line-shaped embossing runs at a slant, arced, or angled, a corresponding movement path of the laser beam can be made possible by a guidance adapted to the shape of the embossing beam, or freely programmable guidance of the laser beam, for example.

Within the framework of the invention, the film web can also be passed by the hot-embossing device and the laser beam device continuously, whereby the weakening line is produced in the running direction of the film web. Such a configuration of the method according to the invention allows an extremely simple production of the film, and without restriction, a single weakening line or several weakening lines can be provided in the crosswise direction of the film. After production of the weakening line, further processing of the film can be provided immediately, whereby film sheets are cut from the film web for the production of individual tear-open packagings. Alternatively, however, the film, as a semi-finished product, can also first be rolled up and stored and transported before further processing. In the further embodiment, the line-shaped embossing is produced in the hot-embossing device by an embossing roller, in the case of production of the weakening line in the running direction of the film web. In this connection, the embossing roller can have a continuous projection on the circumference to produce a continuous line-shaped embossing, or also a projection on the circumference that is interrupted, to produce a uniformly interrupted line-shaped embossing. The laser seam can also be carried out as a continuous or uniformly interrupted line.

The film is preferably co-extruded in multiple layers or laminated. At least one of the two outer layers can be heat-sealed. In the production of a tear-open packaging, the heat-sealable layer allows closure of the packaging by means of sealed seams. Polyolefins, such as polyethylene, polypropylene, polyethylene copolymer, polypropylene copolymer, as well as mixtures of these polymers, are particularly suitable as polymers for the heat-sealable outer layer. Within the scope of the invention, the film can preferably be laminated in multiple layers, and have at least one metallized polymer layer. A very good barrier effect of the film with regard to oxygen permeability and water vapor permeability can be achieved by a thin metal layer, for example vapor-deposited aluminum, so that a tear-open packaging formed from the film securely protects the goods packaged in it.

In a particularly preferred embodiment of the invention, the film has a first outer layer of a heat-sealable polyolefin, and a second outer layer. The second outer layer is cut through, at least in sections, in order to produce the weakening line, and the thickness of the first outer layer is reduced by maximally 10%, preferably by maximally 5%, during production of the weakening line. The method according to the invention can be carried out in such a manner that individual layers are destroyed in the region of the weakening line, in targeted manner, whereby the thickness of the other, adjacent layers remains unchanged, to a great extent.

In addition to a reduction in the layer thickness, the laser beam device and the hot-embossing device can be used to produce brittleness of the material, resulting in better tear-open behavior. Within the scope of the invention, the line-shaped laser seam can be produced before or after the line-shaped embossing, without restrictions. In a preferred embodiment of the invention, however, the line-shaped embossing is first produced in the hot-embossing device.

The method according to the invention can be used for the production of films for different tear-open packagings. Possible packaged goods are, for example, foods, animal feed, hygiene products, sterile objects, and cleaners. It is particularly advantageous if a notch is provided for initiating the tear at the location where the weakening line reaches the edge of the tear-open packaging.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows one embodiment of a device for carrying out the method according to the invention;

FIG. 2 shows another device for carrying out the method according to the invention; and

FIG. 3 shows a sectional view of a film produced using the method according to the invention, in the region of the weakening line.

### DETAILED DESCRIPTION OF THE PREFERRED EMBODIMENT

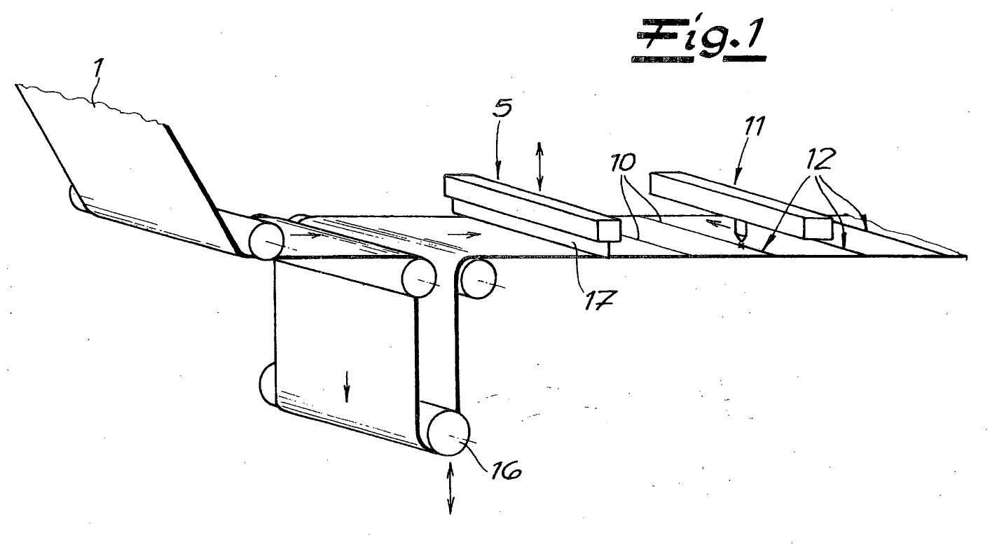

Referring now in detail to the drawings, FIG. 1 shows the individual method steps of a preferred embodiment of the method according to the invention, using a schematic representation. A multi-layer laminated film web 1 having a heat-sealable first outer layer 2 of a polyolefin at the bottom, a second outer layer 3 at the top, and a metallized intermediate layer 4, is continuously fed to a register arrangement having a register roller 16. Register roller 16 is adjustable perpendicular to the running direction of film web 1, for example, and is controlled in such a manner that film web 1 is transported not continuously, but rather in cycles, in the region of a hot-embossing device 5 and a laser beam device 11. Film web 1 is provided with a line-shaped embossing 10 that runs crosswise to the running direction of film web 1, by an embossing beam 17, while the film web is resting in the region of the hot-embossing device 5. Subsequently, film web 1 is transported further to laser beam device 11, in which the progression of line-shaped embossing 10 is followed up by a linear movement of a laser beam—also while film web 1 is at rest. The laser seam produced in this manner and embossing 10 cover each other and jointly form a weakening line 12. Subsequently, individual tear-open packagings can be formed from film web 1, which typically each have one weakening line 12.

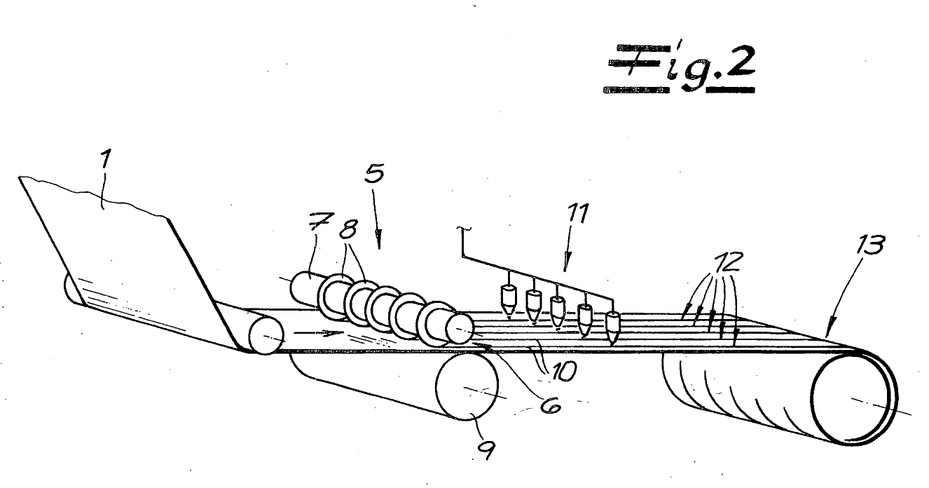

FIG. 2 shows the individual method steps of another embodiment of the method according to the invention, using a device shown schematically. A multi-layer laminated film web 1 having a heat-sealable first outer layer 2 of a polyolefin at the bottom, a second outer layer 3 at the top, and a metallized intermediate layer 4, is continuously fed to a hot-embossing device 5, in which film web 1 is continuously provided with line-shaped embossings 10, in a roller gap 6 between an embossing roller 7 having a plurality of projections 8 and a counter-roller 9. Subsequently, film web 1 is passed to a laser beam device 11, in which a line-shaped laser seam is produced with coverage with every embossing 10. A line-shaped embossing 10 and a line-shaped laser seam together form a weakening line 12, in each instance, in the running direction of film web 1. After production of weakening line 12, film web 1 is rolled up and stored before further processing. Only after storage and transport are film sheets, each having a weakening line 12, cut off from film web 1, for the production of individual tear-open packagings.

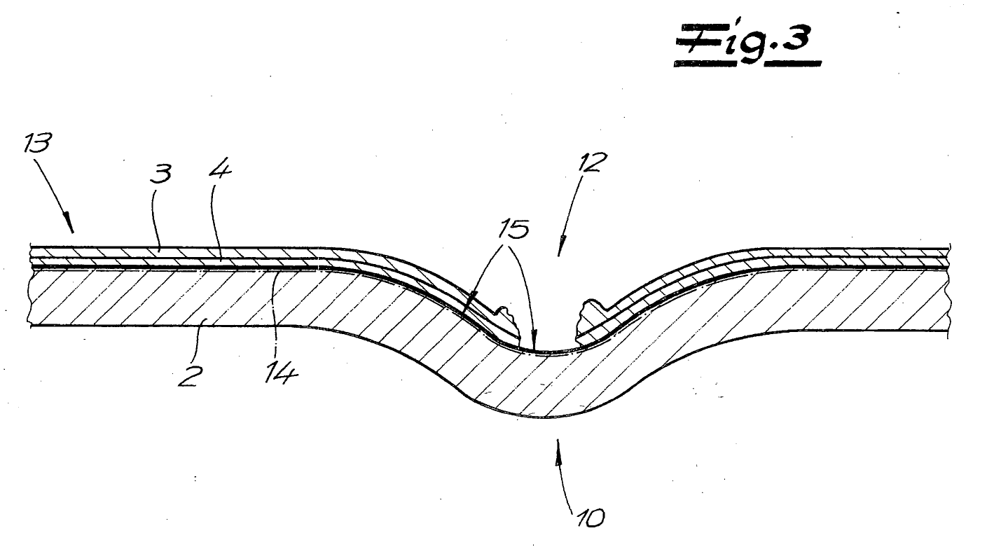

FIG. 3 shows a film 13 provided with a weakening line 12 according to the method according to the invention. A heat-sealable first outer layer 2 is formed from polyethylene (PE) and has a thickness of 90 μm. An intermediate layer 4 of polyethylene terephthalate (PET), onto which aluminum is vapor-deposited on the side facing the first outer layer 2, borders on first outer layer 2 by way of a thin adhesion-imparting layer 14. The total thickness of intermediate layer 4 is 12 μm, and the metallic coating 15 is present in a layer thickness in the range of 50-100 nanometers. A second outer layer 3, having a thickness of 12 μm, made of polyethylene terephthalate (PET), borders on intermediate layer 4. In cross-section, the deformation of film 13 by line-shaped embossing 10 in hot-embossing device 5 can be recognized. In the center of the deformation, the two layers (3, 4) of polyethylene terephthalate are cut through, by the combination of hot-embossing and irradiation by a laser, except for the metallic coating 15.

In order to determine the influence of the weakening on the oxygen permeability and the water vapor permeability, a circular sample having a surface area of 50 cm² was examined in a region of weakening line 12 and in a region without weakening. In the region of weakening line 12, the circle is divided into equal parts. Table 1 shows that the water vapor permeability is hardly influenced by the weakening. The oxygen permeability is increased, but the increased values are insignificant for the intended applications. Since the surface area of weakening line 12 is typically very slight as compared with the total surface area of a packaging bag, a tear-open packaging produced with a film 13 shown demonstrates very good barrier properties overall.

| | without | in the region of the |
|---|---|---|
| | weakening | weakening line |
| Oxygen permeability | 0.8 cm³/(m² * day) | 6.9 cm³/(m² * day) |
| (at 23° C./50% RH) | | |
| Water vapor | 0.22 cm³/(m² * day) | 0.26 cm³/(m² * day) |
| permeability | | |
| (at 23° C./85% RH) | | |

Accordingly, while only a few embodiments of the present invention have been shown and described, it is obvious that many changes and modifications may be made thereunto without departing from the spirit and scope of the invention.

What is claimed is:

1. A method for the production of a film for tear-open packagings having a weakening line, comprising the following steps:
passing a film web having at least one film layer of a thermoplastic plastic to a hot-embossing device;
embossing the film web with a line-shaped embossing;
passing the film web to a laser beam device; and
creating a line-shaped laser seam on the film web via the laser beam device;
wherein the embossing and the laser seam cover each other and jointly form the weakening line.

2. A method according to claim 1, wherein a plurality of weakening lines are created spaced apart in a running direction of the film web.

3. A method according to claim 2, wherein the line-shaped embossing is produced in the hot-embossing device by an embossing beam, and wherein subsequently, in the laser beam device, the laser seam is created by following a progression of the line-shaped embossing by a laser beam in order to produce the weakening line.

4. A method according to claim 1, wherein the film web is continuously passed by the hot-embossing device and the laser beam device and wherein the weakening line is produced in a running direction of the film web.

5. A method according to claim 4, wherein the line-shaped embossing is produced in the hot-embossing device by an embossing roller.

6. A method according to claim 1, wherein the film is co-extruded in multiple layers or laminated so that there are two outer layers, and wherein at least one of the two outer layers is heat-sealable.

7. A method according to claim 6, wherein the film is laminated in multiple layers and has at least one metallized polymer layer.

8. A method according to claim 1, wherein the film has a first outer layer of a heat-sealable polyolefin, and a second outer layer that is cut through, at least in sections, in order to produce the weakening line, and wherein a thickness of the first outer layer is reduced by maximally 10% during production of the weakening line.

9. A method according to claim 1, wherein after production of the weakening line, film sheets are cut from the film web for production of individual tear-open packagings.
